(19) United States
(12) Patent Application Publication
(10) Pub. No.: US 2010/0332961 A1
(43) Pub. Date: Dec. 30, 2010

(54) Automatic link publisher

(76) Inventor: Venkat Ramaswamy, Falls Church, VA (US)

Correspondence Address: VENKAT RAMASWAMY, 700 HIGHLAND AVE., FALLS CHURCH, VA, 22046, US

(21) Appl. No.: 12/493,223

(22) Filed: Jun. 28, 2009

(51) Int. Cl. G06F 17/00; G06F 3/01; G06F 15/16

(52) U.S. Cl. 715/205; 715/745; 709/204

(57) ABSTRACT

This invention is an online system that shows many links to registered users and if the user presses one of modifier keys while clicking on a link, the system in addition to showing the contents of the link, automatically posts the link to the user's public profile.

### FIELD OF INVENTION

This invention pertains to an online computer system that displays several links, people becoming members in the system, public profiles of such members in the system and the content in member's public profiles.

### BACKGROUND OF THE INVENTION

Aggregators:

An aggregator is a website where headlines are collected, usually manually, by the website owner. Examples of this sort of website are the Drudge Report and the Huffington Post. There are also websites like Google News, where aggregation is entirely automatic, using algorithms which carry out contextual analysis and group similar stories together.

A feed aggregator, also known as a feed reader or news reader, is a client software or a Web application which aggregates syndicated web content such as news headlines, blogs and podcasts in a single location for easy viewing.

Google Reader:

Google Reader is a Web-based aggregator, capable of reading Atom and RSS feeds online or offline. Google Reader also includes a public page for each user, in which users can share items by marking them explicitly.

Twitter:

Twitter is a service that enables its users to send and read each others' updates, known as tweets. Tweets are text-based posts of up to 140 characters, displayed on the author's profile page and delivered to other users—known as followers—who have subscribed to them. Senders can restrict delivery to those in their circle of friends or, by default, allow open access. Users can send and receive tweets via the Twitter website, Short Message Service (SMS) or external applications. One can also include HTML links inside their tweets.

U.S. Pat. No. 5,960,411, Hartman , et al.

Hartman et al. claim the novelty as combining previously known steps of ordering an item through a multi-step process into a single action by the user.

### SUMMARY OF INVENTION

Many web sites present hundreds of links to the users and have public profiles where users can share the links they like with other users. But to share a link, a user has to go through a separate sharing process. This invention uniquely combines the process of sharing links with the user action of viewing a link. When the user presses one of modifier keys while clicking on the link, the system in addition to showing the link content also posts the link to the user's public profile.

### DETAILED DESCRIPTION OF THE INVENTION:

A web portal is a website that presents information from diverse sources in a unified way. These websites show many links to the user by aggregating the links manually or by using an automated process or using feed readers. Users click on the links to view the corresponding article or view an image or listen to an audio clip or watch a video. Some of these websites also provide public profile pages for users where they can share links they like.

But to share a link, the user goes through a separate sharing process for each link that he would like to share. For example, in Google Reader, the user has to (a) click once to view the link description, then (b) click on another link to read the content of the link which opens in a new window or tab and then (c) come back to the original window and click on the “share” link under the description to share the link.

The advantage of having such a separate process as Google Reader is that the user decides to share a link only after he reads the content of the link. The disadvantage is that many times the user may not come back to explicitly share a link. As web marketers know, every time a user has to click an extra link, the probability of user taking that action goes down.

This invention executes the sharing step automatically in the background using modifier keys. In computing, a modifier key is a special key on a computer keyboard that modifies the normal action of another key when the two are pressed in combination. In this case, the mouse click action can be modified by pressing one of CTRL, SHIFT or ALT keys. If the member presses one of the modifier keys, the link is automatically included in his profile. In addition, the timestamp can also be included in the profile.

In another embodiment of this invention, the member can choose to share all the links he clicks on. Every link that he clicks will automatically appear on his profile. If the member does not want to share a link, then only he presses the modifier keys.

In this invention, the act of sharing happens before the member views the content of the link. Hence, there will be cases where the member wants to not share a link that he previously shared. To do this, the member can go back to the link and click on it using the modifier keys. Every time the member clicks on the link, the system looks at the modifier key and takes the appropriate action to share or not share the link in the member's profile.

An embodiment of this invention can include features similar to social network where members can declare each other as friends. Members can also set up their profiles to be viewed by such friends only.

An embodiment of this invention can allow one member to follow one or more other members. As these other members share links in their profile, this member's Graphical User Interface can automatically update to show those links in real-time. Twitter provides a “follower” model for micro blogs and micro blogs can include links, but tweets are explicit posts made by the user. In this invention, a link is shared automatically as the member just clicks on it to view the content.

An embodiment of this invention can record and show metrics related to each link. The system can show how many members read each link and how many members shared the link in their profile. It can also show all the members that read a link.

An embodiment of this invention can allow other websites to post a link to the member's profile. When the member clicks on a link in another website that website would show the content of the link on the browser but it would also use a hidden frame in the browser to redirect to this system with the link. If this system can identify the member from the cookie information, the link will be posted to the member's profile without any user interaction. If this system cannot identify the user from the cookie information, then it will prompt the member to login to the system and upon login automatically post the link that the member clicked on the other website.

An embodiment of this invention can use collaborative filtering to recommend other links to the member. Using this technique, the system will look at all the other members that clicked on the same links as this member and recommend other links that those members clicked on.

What is claimed is:

1. A online system in which (a) a person becomes a member by registering with an username and password and such a person is henceforth referred as a “member” and (b) each member has a public profile in the system and (c) the system shows many HTML links to the member on the user interface and (d) such html links may point to content within the system or external to the system and (e) if the member presses one of modifier keys such as CTRL, ALT or SHIFT keys on the keyboard while clicking the mouse on a HTML link, the system in addition to displaying the document associated with the HTML link on the user interface, also posts the link to the member's public profile.

2. The system as set forth in claim 1 wherein said system constructs the links from web feeds such as RSS feeds or ATOM feeds.

3. The system as set forth in claim 1 wherein the links are constructed by automated algorithms that scavenge other websites.

4. The system as set forth in claim 1 wherein the links are constructed by members of the system.

5. The system as set forth in claim 1 wherein the links are constructed by Humans editors.

6. The system as set forth in claim 1 wherein the system could additionally show a title and brief description for each link.

7. The system as set forth in claim 1 wherein said system alternately posts the link to the member's profile each time the member clicks on the link and does not post the link to his profile when the member presses one of modifier keys while clicking on the link.

8. The system as set forth in claim 1 wherein said system additionally allows members to become friends by following a mutual approval process as in social networks.

9. The system as set forth in claim 1 and claim 8 wherein said member could additionally set his profile to be viewed by his friends only.

10. The system as set forth in claim 1 and claim 8 wherein the system includes said member's friends in his public profile.

11. The system as set forth in claim 1 wherein said member could additionally follow one or more other members in the system and as those other members post links to their profiles, said member is automatically notified.

12. The system as set forth in claim 1 and claim 11 wherein when another member that said member follows posts a link to her profile said member's user interface automatically updates to show the name of the other member and the link that she clicked on.

13. The system as set forth in claim 1 wherein said system can be accessed by client software over the internet or private intranets.

14. The system as set forth in claim 1 wherein said system can be used through a web browser or standalone client software or through a module of another software or through a software on a wireless device.

15. The system as set forth in claim 1 wherein said system records and displays usage metrics on each link in the system.

16. The system as set forth in claim 1 and claim 15 wherein the metrics include the number of members that clicked on each link.

17. The system as set forth in claim 1 and claim 15 wherein the metrics include the number of members that included each link on their profile.

18. The system as set forth in claim 1 wherein other systems can post links to the member's profile on the said system.

19. The system as set forth in claim 1 wherein the system can recommend other links to the member based on the links that he clicked using collaborative filtering technique.
